(19) United States
(12) Patent Application Publication
(10) Pub. No.: US 2013/0304951 A1
(43) Pub. Date: Nov. 14, 2013

(54) METHODS AND STRUCTURE FOR IMPROVED AND DYNAMIC ZONING IN SERIAL ATTACHED SCSI EXPANDERS

(71) Applicants: Ankit Goel, Mahadevpura (IN); Abhijit Suhas Aphale, Rahul Park (IN); Manjusha Gopakumar, Bangalore (IN)

(72) Inventors: Ankit Goel, Mahadevpura (IN); Abhijit Suhas Aphale, Rahul Park (IN); Manjusha Gopakumar, Bangalore (IN)

(73) Assignee: LSI CORPORATION, Milpitas, CA (US)

(21) Appl. No.: 13/468,124

(22) Filed: May 10, 2012

(51) Int. Cl. G06F 13/12

(52) U.S. Cl. 710/65

(57) ABSTRACT

Methods and structure for dynamically modifying SAS Zoning Features of a SAS expander based on present operating status of the expander. Rules are provided and interpreted within the expander to define changes to be made to the present SAS Zoning Features based on changes to the present operating status of the expander. The present operating status may be, for example, the present day, date, time of day, etc. Exemplary rules may define a modification to the zone group identifier to be associated with a PHY of the expander based on the present operating status of the expander. Exemplary rules may also define a modification to the zone permission defined for a pair of zone group identifiers. Further features and aspects hereof provide for a read-only zone permission value in addition the standards of the SAS specification.

### BACKGROUND

1. Field of the Invention

The invention relates generally to Serial Attached SCSI (SAS) configuration management and more specifically relates to methods and structure for improved flexibility in defining zoning permissions in a SAS expander and for doing so dynamically.

2. Discussion of Related Art

A SAS domain comprises one or more SAS initiator devices coupled with one or more SAS target devices through one or more SAS expanders. The expanders provide switching capabilities to allow each SAS initiator to couple with any desired, configured set of SAS target devices. Some SAS expanders compliant with more recent versions of SAS standards provide for definitions of zone groups and a zone permission associated with pairs of zone groups. Each physical link of the expander (each PHY) may be configured by an administrator to be associated with one of a plurality of zone groups defined within the SAS expanders. Each zone group is associated with a zone group identifier (i.e., an index value from 0 through 255). A zone group permissions table is then configured by an administrator indicating which zone groups are permitted to communicate with which other zone groups. In other words, for each pair of zone group identifiers, a zone permission value may be defined to indicate that devices coupled through PHYs associated with the first group of the pair are or are not allowed to access devices coupled with PHYs associated with the second group of the pair.

The configuration of SAS expanders to associate each PHY with a zone group and to define the permitted and disallowed access is generally a manual task performed by an administrative user (e.g., utilizing administrative or management tools communicating with the one or more SAS expanders). In general, an administrative user determines the appropriate configuration for the entire SAS domain and defines appropriate zone permissions for each of the defined zone groups. Further, the administrative user determines appropriate associations of each PHY (and thus each SAS initiator and SAS target device coupled through each PHY) with a corresponding zone group identifier. By way of example, in applying zoning in a large enterprise, one zone group identifier may be defined for PHYs coupled with devices (initiators and targets) associated with a financial group of the enterprise while another zone group identifier may be defined PHYs coupled with devices associated with an engineering group of the enterprise. Yet another zone group identifier could be defined for upper management of the enterprise. Zone permission table entries may then be defined by an administrator such that devices coupled with PHYs associated with the engineering group cannot access devices coupled with PHYs associated with the financial group. Devices coupled with PHYs associated with the upper management group may be granted full access to all devices associated with either the engineering or financial groups.

The data and/or structures within a SAS expander defining the SAS zoning configuration are referred to generally herein as “Zoning Features”. As presently practiced, configuration of SAS Zoning Features is generally a manual process and is defined statically when they SAS domain is first configured for use in an enterprise. It is common that such an administrative user may change the SAS zoning configuration information as the enterprise decides to alter the permitted access and/or as devices are added, subtracted, or modified in the SAS domain. Problems arise in such static configurations when zone group definitions and associated zone permissions need to be changed on a frequent basis for common procedures performed within the enterprise. Such frequent changes performed by a manual process may be prone to human error such that the enterprise may become misconfigured or in some manner unusable for its intended purpose.

Thus it is an ongoing challenge to provide for frequent or common configuration changes for zone groupings and associated zone group permissions in a SAS domain.

### SUMMARY

The present invention solves the above and other problems, thereby advancing the state of the useful arts, by providing methods and structure for dynamically modifying SAS Zoning Features of a SAS expander based on present operating status of the expander. Rules are provided (e.g., by an administrative user of the expander) that define changes to be made to the SAS Zoning Features within the expander based on changes to the operating status of the expander. The present operating status may be, for example, the present day, date, time of day, etc. Exemplary rules may define a change to the zone group identifier to be associated with a PHY of the expander based on the present operating status of the expander. Exemplary rules may also define a modification to the zone permission defined for a pair of zone group identifiers. Further features and aspects hereof provide for an additional zone permission value for read-only access in addition to the no access and full read/write access defined by the SAS standards.

In one aspect hereof, a method is provided operable in a SAS expander for managing SAS Zoning Features of the expander. The method comprises providing rules within the expander for dynamic modification of SAS Zoning Features of the expander and dynamically modifying, by operation of the expander, SAS Zoning Features within the expander in accordance with the rules.

Another aspect hereof provides a method for dynamically modifying Zoning Features in a SAS expander. The method comprises retrieving a rule within the expander defining desired Zoning Features for a corresponding PHY of the expander and modifying, by operation of the expander, a Zoning Feature of the PHY in accordance with the retrieved rule. The Zoning Feature comprises one or more of: the association of the PHY with a zone group identifier and the association of a zone group permission with the PHY. The zone group permission comprises one of: no access, read-only access, or read-write access.

Yet another aspect hereof provides a SAS expander comprising a rules memory adapted to store rules for dynamically modifying SAS Zoning Features of the expander and a zoning rules engine module coupled with the rules memory and adapted to dynamically modify SAS Zoning Features of the expander in accordance with the rules stored in the rules memory.

### BRIEF DESCRIPTION OF THE DRAWINGS

FIG. 1 is a block diagram of an exemplary SAS expander enhanced in accordance with features and aspects hereof to permit dynamic modification to SAS Zoning Features of the expander as defined by rules based on the present operating status of the expander.

FIGS. 2 and 3 are flowcharts describing exemplary methods in accordance with features and aspects hereof to permit dynamic modification to SAS Zoning Features of the expander as defined by rules based on the present operating status of the expander.

FIG. 4 is a flowchart describing an exemplary method for enforcing a new read-only zone permission value within an expander in accordance with features and aspects hereof.

### DETAILED DESCRIPTION OF THE DRAWINGS

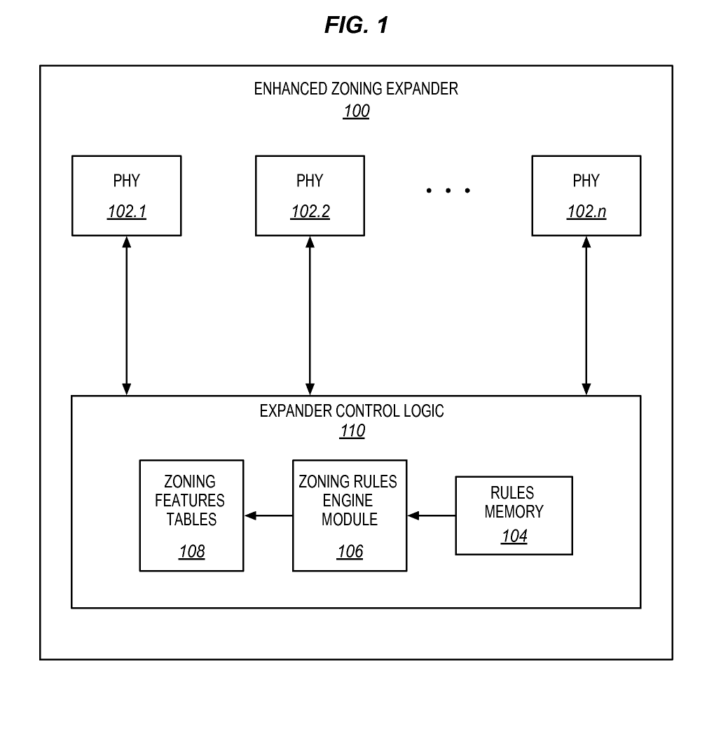

FIG. 1 is a block diagram of an exemplary SAS zoning expander 100 enhanced in accordance with features and aspects hereof. Expander 100 comprises a plurality of PHYs 102.1 through 102.n each adapted to couple with a SAS initiator device, a SAS target device, or other SAS expanders of a larger SAS domain. Expander 100 further comprises control logic 110 adapted for general control of functions of expander 100. Control logic 110 may comprise suitably programmed instructions executed by a general or special purpose processor of logic 110 and/or may comprise one or more custom circuits adapted for specific control features of logic 110. In particular, to implement Zoning Features of expander 100, Zoning Features tables 108 may be stored in a suitable memory component within expander 100. Zoning Features tables may comprise any suitable data and/or structures (typically as described in SAS specifications) that associate a particular zone group identifier with each PHY 102.1 through 102.n and that define a zone permission describing a level of access allowed between PHYs associated with each of the defined zone group identifiers. Standard zoning data and structures are well understood by those of ordinary skill in the art and substantially defined in the SAS specifications.

In accordance with features and aspect hereof control logic 110 is further enhanced to comprise rules memory 104 adapted for storing rules for dynamic modification of information stored in Zoning Features tables 108. Control logic 110 further comprises zoning rules engine module 106 adapted to interpret the rules stored in memory 104 to implement desired dynamic modifications to Zoning Features tables 108. Rules memory 104 may comprise any suitable memory component including volatile or nonvolatile RAM components. Further, rules memory 104 may simply comprise a portion of other suitable memory components utilized for other purposes within control logic 110. Zoning rules engine module 106 may comprise suitably programmed instructions executed by the general or special purpose processor of expander 100 and/or may comprise suitably designed custom circuits to provide the functionality described herein.

In operation, a set of rules are created by an administrative user and stored in rules memory 104. In general, the rules created by such an administrative user define modifications to be made to parameters encoded within Zoning Features tables 108 in response to a defined operating status of expander 100. In response to sensing particular operating status of expander 100, zoning rules engine module 106 locates any applicable rules in rules memory 104 and modifies parameters in Zoning Features tables 108 according to applicable rules so located. Exemplary rules may define changes to the zone group identifier to be associated with one or more of PHYs 102.1 through 102.n in response to sensing a particular defined operating status of expander 100. Further, other exemplary rules may define changes to the zone permission values to modify the level of access provided between two defined zone group identifiers in response to sensing particular changes in operating status of expander 100. The operating status sensed by zoning rules engine module 106 may comprise, for example, the present day and/or time (e.g., day of the week, month, or year, time of day, etc.). For example, an administrator may create rules that normally preclude access to particular target devices coupled with particular PHYs of the expander but change the zoning permission at certain times or days to allow access to a device for certain forms of administrative access (e.g., backup procedures, volume snapshot procedures, etc.).

SAS standards define the zone permission values as indicating either no access or full (read/write) access). Features and aspects hereof provide for read-only access in addition to the zone permissions provided by the SAS standards. Thus, zone permissions may be defined providing no access between a pair of zone groups, limited read-only access, or full read/write access. In general operations of a SAS expander, an initiator device attempts to establish a connection with a target device identified by its SAS address. The initiator transmits a SAS Open Address Frame (OAF) to the target device. The OAF is received by a SAS expander through a PHY and the expander determines an appropriate route to forward the OAF to the identified target via some PHY of the expander. In accordance with SAS standard operations, control logic 110 may respond to an OAF by allowing the Open Address Frame to be successfully completed where full access is specified by the zone permission for the pair of zone group identifiers. If the OAF is successfully completed, the initiator may then forward additional frames including, in particular, a frame comprises a SCSI command to read or write data. Conversely, if the zone permissions for the PHY from which the OAF is received and the PHY to which the OAF is to be routed indicate no access is permitted, logic 110 rejects the Open Address Frame with an appropriate status code. In accordance with features and aspects thereof, the additional limited read-only access permission allows an Open Address Frame to be completed successfully (to establish a connection between devices coupled with PHYs of a pair of zone groups) but the enhanced expander then monitors subsequent requests to determine if a write access has been requested by a subsequent data transfer command (i.e., transmitted via the SAS SSP or STP protocols). If such a write request is detected by control logic 110, expander 100 may immediately reject the write request by returning an appropriate error status indicating that the targeted device is write protected.

Those of ordinary skill in the art will recognize numerous additional and equivalent elements that may be present in a fully functional SAS expander. Such additional and equivalent elements are omitted herein for simplicity and brevity of this discussion.

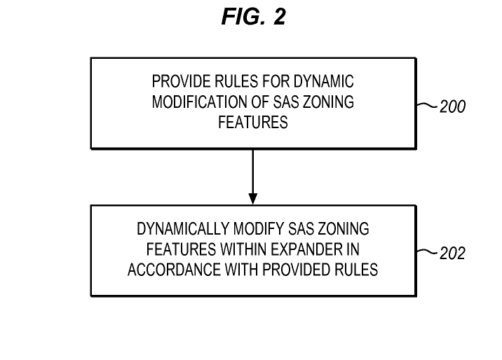

FIG. 2 is a flowchart describing an exemplary method for dynamic modification of SAS Zoning Features within a SAS expander in accordance with features and aspects hereof. The method of FIG. 2 may be performed within an enhanced SAS expander such as SAS expander 100 of FIG. 1 and more specifically may be performed within enhanced control logic 110 of SAS expander 100 of FIG. 1. At step 200, one or more rules are provided defining desired dynamic modification of SAS Zoning Features. The rules may be created by an administrative user and provided to the SAS expander by any suitable configuration or managerial interface. Some SAS expanders provide for dedicated managerial ports as a communication path for such administrative functions. In other exemplary embodiments, the Serial Management Protocol (SMP) of the SAS standards may be utilized to provide such configuration information defining the rules for dynamic modification of SAS Zoning Features. At step 202, control logic of the SAS expander (e.g., a rules zoning rules engine module within the expander) essentially continually monitors the status of the SAS expander and applies any applicable rules based on such monitored operating status to dynamically modify SAS Zoning Features within the expander. In some exemplary embodiments, the rules engine may check the operating status on a periodic basis or in response to any changes. In still other exemplary embodiments where the operating status in the rules is defined in terms of dates or times, the rules engine may be awaken when a rule is set to “trigger” at a particular time and/or date. As noted above, a rule may define a change to the zone group identifier to be associated with one or more PHYs of the SAS expander and/or may define a change in the zone permission to be associated with a corresponding pair of zone group identifiers.

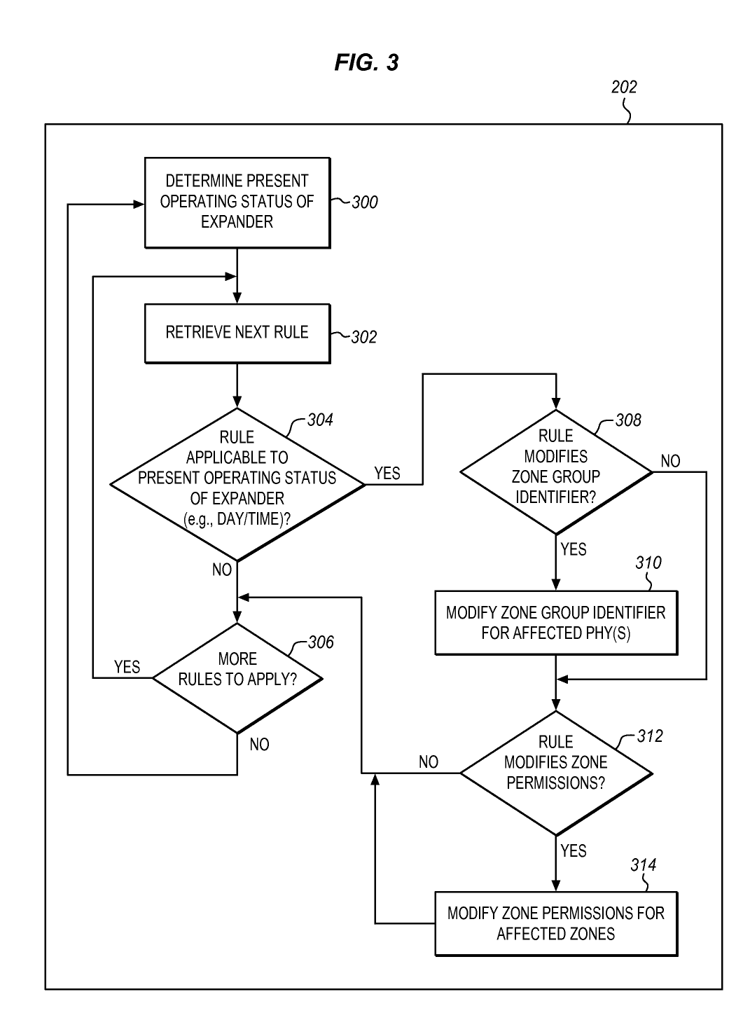

FIG. 3 is a flowchart describing exemplary additional details of the processing of step 202 of FIG. 2 to dynamically modify Zoning Features within the SAS expander in accordance with defined rules and based on the present operating status of the expander. At step 300, logic within the enhanced expander determines the present operating status of the expander. As noted, operating status may comprise present day, time of day, etc. Steps 302 through 314 are then iteratively operable to evaluate each of the provided rules to identify applicable rules based on the present day and time and to apply any applicable rule to change an aspect of the SAS Zoning Features. Step 302 retrieves the next rule of those provided by an administrative user. As noted above, the rules provided by administrative user may be stored within the SAS expander in any appropriate memory component and may be structured in any suitable manner. At step 304, the expander determines whether the retrieved rule is applicable based on the present operating status of expander. For example, if the rule defines a particular day or time of day for application of the rule, the date and/or time defined in the rule may be compared with the present day and/or time to determine whether the rule is presently applicable. If step 304 determines that the retrieved rule is not presently applicable, step 306 determines whether more rules remain to be checked. If so, processing continues looping back to step 302 to retrieve a next rule for evaluation. When all rules have been checked based on the present operating status of the expander, processing continues looping back to step 300 (potentially after a suitable delay) to again determine the present operating status of the expander and to repeat the process of provided rules applicable to that present operating status.

If step 304 determines that a retrieved rule is presently applicable based on the operating status of the expander, step 308 determines whether the rule is requesting dynamic modification of a zone group identifier associated with one or more identified PHYs. If not, processing continues at step 312 as discussed below. If so, step 310 interprets the rule and appropriately modifies the zone group identifier for one or more identified PHYs of the SAS expander. For example, a PHY may be associated with a first zone group identifier for particular times of day or particular days and associated with another zone group identifier on other days or times. Following the modifications of Zoning Features at step 310, step 312 next determines if the retrieved rule modifies zone permissions for one or more pairs of zone group identifiers. If not, processing continues at step 306 until all rules have been evaluated for the present operating status of the SAS expander. If step 312 determines that the retrieved rule requests modification of zone permission information, step 314 is operable to effectuate the defined modification for the zone permission for one or more pairs of zone group identifiers. For example, zone permission associated with a particular pair of zone group identifiers may be changed from no access to full read/write access at certain times of days or on certain days. In like manner zone permissions may be changed among any of the possible zone permissions defined. As noted above, features and aspects hereof provide for an additional form of zone permission to be defined to allow read-only access between PHYs associated with a defined pair of zone group identifiers. Thus, SAS standard zone permissions including no access and full access as well as the enhanced read-only access may be defined within a rule to permit changes among any of these three types of zone permissions based on present operating status of expander. Processing then continues at step 306 until all rules have been evaluated and applied as appropriate based on the present operating status of expander.

As noted above, the monitoring or present operating status of the expander may be performed essentially continuously as described in FIG. 3. In other exemplary embodiments where rules define the present operating status in terms of day and/or time, the method may be scheduled or triggered to operate based on the next day/time to come that is defined within any rule provided within the expander.

The following table suggests a structure for exemplary rules for the definition of dynamic modification of Zoning Features based on present operating status (e.g., day and/or time of day).

| | Zone | Affected | | Start | | Zone |
|---|---|---|---|---|---|---|
| Entry | Group ID | PHY(s) | Days | Time | End Time | Permission |
| 1 | 1 | 1 | All | 0800 | 1000 | Read Only |
| 2 | 1 | 2 | Tue-Fri | 0800 | 1000 | Read Only |
| 3 | 1 | 3 | All | 0800 | 1000 | Read Only |
| 4 | 2 | 4 | All | 1200 | 1200 | Read/Write |
| 5 | 2 | 5 | All | 1000 | 1200 | Read/Write |
| 6 | 2 | 2 | Mon | 1000 | 1200 | Read/Write |
| 7 | 3 | 7 | All | 1200 | 1400 | Read Only |
| 8 | 3 | 8 | All | 1200 | 1400 | Read Only |
| 9 | 4 | 9 | All | 1200 | 1400 | Read/Write |
| 10 | 4 | 10 | All | 1200 | 1400 | Read/Write |
| 11 | 5 | 11 | All | 0100 | 2400 | No Access |
| 12 | 5 | 11 | All | 0000 | 0100 | Read/Write |

Some entries in the above table demonstrate exemplary use of features and aspects hereof. For example, entry 2 demonstrate a PHY (PHY 2) that is dynamically modified to be associated with zone group identifier 1 on Tuesday through Friday starting at 8:00 AM and ending at 10:00 AM. During these periods of time, only read access is permitted to devices coupled through PHY 2. Entry 6 indicates that PHY 2 is associated with zone group identifier 2 on Mondays from 10:00 AM through 12:00 (noon) and provides full read/write access during that period. Or, for example, entry 11 indicates that PHY 11 is associated with zone group identifier 5 on all days with no access permitted from 1:00 AM through midnight but allows full read/write access (still associated with zone group identifier 5) from midnight through 1:00 AM. Such dynamic changes may be useful when a storage volume associated with a zone group identifier may be used for some administrative purposes at certain times of certain days and for other purposes at other times. Or, for example, where device or volume is to be accessible to one group of an enterprise for certain periods of time and accessible another group of the enterprise at other periods of time. Those of ordinary skill in the art will recognize that such a table may comprise any number of entries to fully define rules for dynamic modifications of Zoning Features during all periods of operation for all PHYs of the expander. In other exemplary embodiments, default Zoning Features may be defined such that the default zone group identifier associations and zone permissions are used to define Zoning Features for all PHYs for any periods of time for which no entry is found in the table. In still other embodiments, dates may be specified as a present operating status of the expander at which the corresponding rule is to be applied. Numerous equivalent structures for defining and storing rules for dynamic modification of Zoning Features will be apparent to those of ordinary skill in the art in view of the above examples.

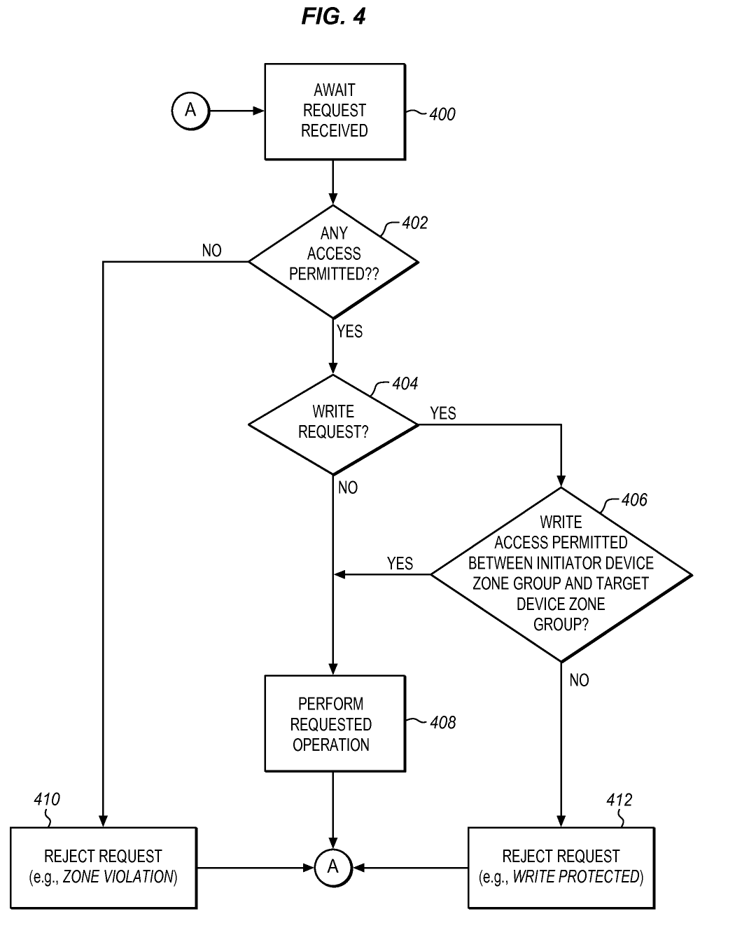

FIG. 4 is a flowchart describing another exemplary method for processing the enhanced zone permissions defined in accordance with features and aspects hereof Specifically, as noted above, features and aspects hereof define a read-only type of zone permission in addition to the SAS standard zone permissions allowing no access or full access. Thus, the method of FIG. 4 monitors received requests from a device coupled with a PHY associated with a first zone group identifier directed to a device coupled with a PHY associated with a second zone group identifier to assure that the newly defined read-only access may be enforced by operation of the SAS expander. The method of FIG. 4 may be operable in an enhanced expander such as expander 100 of FIG. 1 and more specifically may be operable within control logic 110 of expander 100 of FIG. 1.

At step 400, the expander awaits receipt of a requested operation directed from an initiator device to a target device (each addressed by its corresponding SAS address and routed through corresponding PHYs of the SAS expander). Upon receipt of such a request, step 402 determines whether any access is allowed between the PHYs identified to route the received request to the target device. In other words, if no access is permitted by the presently configured zone permission for the zone group identifier associated with the PHY of the initiator device and zone group identifier associated with the PHY coupled with the target device, then the request is rejected at step 410 (i.e., returning a “ZONE VIOLATION” status code to the initiator device). Processing then continues looping back to step 400 as indicated by label “A”.

If some level of access is permitted, step 404 next determines whether the received request represents a write operation directed to a target device coupled through a corresponding PHY of the SAS expander. If not, step 408 processes the request normally by routing the non-write request to the identified target device through the appropriate PHY in accordance with standard SAS expander processing. If step 404 determines that the request is for a write operation (e.g., a SCSI write request), then step 406 next determines whether write access is permitted between the associated pair of zone group identifiers. In other words, step 406 determines whether the zone group identifier associated with the PHY of the expander coupled with initiator device is permitted to access, for purposes of writing data, the zone group identifier associated with the PHY of the expander coupled with the addressed target device. If so, step 408 performs the requested write operation by routing the request to the target device through the appropriate PHY in accordance with standard SAS features. Processing then continues looping back to step 400 as indicated by label “A”. If the requested write access is not permitted (e.g., read-only access is presently configured for the pair of zone group identifiers), step 412 rejects the request returning a write protected status to the requesting initiator. Processing then continues at step 400 as indicated by label “A”.

Those of ordinary skill in the art will readily recognize numerous additional and equivalent steps that may be present in the methods described by FIGS. 2 through 4. Such additional and equivalent steps are omitted herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method operable in a Serial Attached SCSI (SAS) expander for managing SAS Zoning Features of the expander, the method comprising:
providing rules within the expander for dynamic modification of SAS Zoning Features of the expander; and
dynamically modifying, by operation of the expander, SAS Zoning Features within the expander in accordance with the rules.

2. The method of claim 1
wherein the step of providing rules further comprises providing rules to associate a PHY of the expander with a zone group identifier in accordance with present operating status of the expander.

3. The method of claim 2
wherein the present operating status comprises one or more of a day, a date, and a time of day.

4. The method of claim 1
wherein the step of providing rules further comprises providing rules to modify a zone group permission associated with a pair of zone group identifiers in accordance with present operating status of the expander.

5. The method of claim 4
wherein the present operating status comprises one or more of a day, a date, and a time of day.

6. The method of claim 1
wherein the step of providing rules further comprises providing rules to modify a zone group permission associated with a pair zone group identifiers wherein the zone group permission comprises one of: no access, read-only access, or read-write access.

7. The method of claim 6 further comprising:
detecting that an initiator device coupled with a PHY of the expander associated with a first zone group identifier of the pair has transmitted a write request to a target device coupled with a PHY of the expander associated with a second zone group identifier of the pair;
responsive to detecting the write request, detecting whether the zone group permission associated with the pair of zone group identifiers precludes write access by the initiator device to the target device; and
responsive to detecting that write access is precluded, performing the additional steps of:
returning a write protected status to the initiator device; and
forcing termination of the write request at the target device.

8. The method of claim 6 further comprising:
detecting that an initiator device coupled with a PHY of the expander associated with a first zone group identifier of the pair has transmitted a write request to a target device coupled with a PHY of the expander associated with a second zone group identifier of the pair;
responsive to detecting the write request, detecting whether the zone group permission associated with the pair of zone group identifiers precludes write access by the initiator device to the target device; and
responsive to detecting that write access is precluded, performing the additional steps of:
returning a write protected status to the initiator device; and
precluding transmission of the write request to the target device.

9. A Serial Attached SCSI (SAS) expander comprising:
a rules memory adapted to store rules for dynamically modifying SAS Zoning Features of the expander; and
a zoning rules engine module coupled with the rules memory and adapted to dynamically modify SAS Zoning Features of the expander in accordance with the rules stored in the rules memory.

10. The expander of claim 9
wherein the rules comprise information that associates a PHY of the expander with a zone group identifier in accordance with present operating status of the expander, and
wherein the zoning rules engine module is further adapted to determine the present operating status of the expander and is further adapted to associate a PHY with a zone group identifier in accordance with the present operating status of the expander.

11. The expander of claim 10
wherein the present operating status of the expander comprises one or more of a day, a date, and a time of day.

12. The expander of claim 9
wherein the rules comprise information to associate a zone group permission with a pair of zone group identifiers in accordance with present operating status of the expander, and
wherein the zoning rules engine module is further adapted to determine the present operating status of the expander and further adapted to associate a zone group permission with the pair of zone group identifiers in accordance with the present operating status of the expander.

13. The expander of claim 12
wherein the present operating status of the expander comprises one or more of a day, a date, and a time of day.

14. The expander of claim 12
wherein the zone group permission comprises one of: no access, read-only access, or read-write access.

15. The expander of claim 14
wherein the zoning rules engine module is further adapted to detect that an initiator device coupled with a PHY of the expander associated with a first zone group identifier has transmitted a write request to a target device coupled with a PHY of the expander associated with a second zone group identifier,
wherein the zoning rules engine module is further adapted, responsive to detecting the write request, to detect whether the zone group permission associated with the pair of zone group identifiers precludes write access to the target device by the initiator device, and
wherein the expander is adapted, responsive to detecting that write access is precluded, to return a write protected status to the initiator device and is further adapted to force termination of the write request at the target device.

16. The expander of claim 14
wherein the zoning rules engine module is further adapted to detect that an initiator device coupled with a PHY of the expander associated with a first zone group identifier has transmitted a write request to a target device coupled with a PHY of the expander associated with a second zone group identifier,
wherein the zoning rules engine module is further adapted, responsive to detecting the write request, to detect whether the zone group permission associated with the pair of zone group identifiers precludes write access to the target device by the initiator device, and
wherein the expander is adapted, responsive to detecting that write access is precluded, to return a write protected status to the initiator device and is further adapted to preclude transmission of the write request to the target device.

17. A method for dynamically modifying Zoning Features in a Serial Attached SCSI (SAS) expander, the method comprising:
retrieving a rule within the expander defining desired Zoning Features for a corresponding PHY of the expander; and
modifying, by operation of the expander, a Zoning Feature of the PHY in accordance with the retrieved rule, wherein the Zoning Feature comprises one or more of: the association of the PHY with a zone group identifier and the association of a zone group permission with the PHY, wherein the zone group permission comprises one of: no access, read-only access, or read-write access.

18. The method of claim 17 further comprising:
determining the present operating status of the expander,
wherein the retrieved rule comprises a corresponding operating status of the expander, and
wherein the step of modifying further comprises modifying the Zoning Feature in accordance with the retrieved rule when the present operating status of the expander matches the corresponding operating status of the retrieved rule.

19. The method of claim 18
wherein the operating status comprises one or more of a day, a date, and a time of day.
